(19) United States
(12) Patent Application Publication
(10) Pub. No.: US 2008/0091862 A1
(43) Pub. Date: Apr. 17, 2008

(54) Network System, Master Device, Slave Device, and Start-Up Control Method for Network System

(76) Inventor: Seiji Hiraka, Miyagi (JP)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/628,095

(22) PCT Filed: Oct. 28, 2005
(86) PCT No.: PCT/JP05/20243

§ 371 Date: Dec. 28, 2007

(30) Foreign Application Priority Data
Oct. 29, 2004 (JP) 2004-316643

(51) Int. Cl. G06F 13/18

(52) U.S. Cl. 710/110

(57) ABSTRACT

A network system (10) comprises a master device (5) and a plurality of slave devices (1, 2, 3), and those devices are serially connected to one another in such a way that the master device (5) comes to the most upstream side, thereby configuring an optical multidrop network which ensures data transmission and reception by optical communications among contiguous devices. Each of the slave devices (1, 2, 3) self-controls so as to be in such a state as not to receive data from any slave device on the downstream side when starting an operation, and the master device (5) controls the individual slave devices (1, 2, 3) sequentially from the upstream side to the downstream side in such a way that each slave device is capable of receiving data from a downstream side slave device.

### TECHNICAL FIELD

The present invention relates to a network system or the like which transmits and receives data by optical communications among devices.

### BACKGROUND ART

A technology which ensures data transmission and reception among plural devices, such as a master device and slave devices, is known (for example, see Japanese Patent Publication No. 3279795, Japanese Patent Publication No. 3129903, Unexamined Japanese Patent Application KOKAI Publication No. 2002-176440, Unexamined Japanese Patent Application KOKAI Publication No. 2000-349768, and Unexamined Japanese Patent Application KOKAI Publication No. 2001-24645).

A multidrop network which ensures data transmission and reception among devices by optical communications is also known. The multidrop network comprises a master device and slave devices serially connected to one another, the master-device side being the upstream side.

Each of the slave devices which constitute the multidrop network has terminals for transmitting and receiving data by optical communications to and from a slave device on the upstream side and a slave device on the downstream side. To be more precise, each slave device has an upstream side data reception terminal for receiving data from a slave device on the upstream side, an upstream side data transmission terminal for transmitting data toward a slave device on the upstream side, a downstream side data reception terminal for receiving data from the slave device on the downstream side, and a downstream side data transmission terminal for transmitting data toward the slave device on the downstream side.

The transmission terminal and the reception terminal of the contiguous devices are connected together by a fiber-optic cable, which allows the devices to transmit and receive data by optical communications.

The slave device locally uses data received via the upstream side data reception terminal, and transmits that data toward the downstream side via the downstream side data transmission terminal. Further, the slave device transmits data received via the downstream side data reception terminal or data generated locally toward the upstream side via the upstream side data transmission terminal.

In such a network, each slave device stores a unique ID for identifying itself, while the master devices stores the IDs of the individual slave devices.

The master device transmits a packet including the ID of each slave device, a command and data. The slave device receives this packet, and transmits the received packet toward the downstream side. If the ID included in the received packet matches with the ID stored by the slave device itself, the slave device executes an operation in accordance with the command and data included in that packet, and transmits an acknowledgement packet toward the upstream side. The acknowledgement packet includes an acknowledgement which indicates the correct reception of the packet transmitted from the master device, and the ID of that slave device. Upon reception of the acknowledgement packet from the slave device which has received the packet transmitted from the master device, the master device recognizes that the slave device has correctly received the command data.

The downmost slave device among the devices which constitute the multidrop network should be able to transmit a packet toward the upstream side, and need not receive data via the downstream side data reception terminal. Therefore, the fiber-optic cable is not connected to the downstream side data transmission terminal and downstream side data reception terminal of the downmost slave device.

If the downstream side data reception terminal of the slave device is kept open, external noise light makes noise signals and the slave device transmit the noise. This may result in a malfunction of the multidrop network.

As a solution to avoid such a risk, there is a method of providing a light block jig on the light receiving portion of the downstream side data reception terminal of the slave device on the most downstream side and preventing the generation of a noise signal due to external noise light. Even the light block jig may be provided, an analog circuit of the optical-to-electrical signal converter makes noise signals.

There is also a method of connecting an electrical circuit which performs carrier detection of light to the light receiving portion of the downstream side data reception terminal of the slave device so as not to create data if the electrical circuit does not detect a carrier. There is, however, a problem such that the integrated circuit (IC) or the like which constitutes such an electrical circuit is expensive, and is difficult to obtain.

It is required that a slave device which constitutes the multidrop network be optionally added or removed, and be adapted for a change in optical path. Accordingly, it is required to dynamically set the ID of the slave device, and any slave device is required to function as the slave device on the most downstream side. Accordingly, the above-described measures against noise should be applied to all the slave devices which constitute the multidrop network.

### DISCLOSURE OF INVENTION

The present invention has been made in view of the above-described circumstances, and it is an object of the invention to provide a network system or the like in which an optical multidrop network is configured, and which ensures addition and removal of a device constituting a node and alteration of an optical path as needed.

To solve the problems, a network system according to the first aspect of the invention comprises a master device (5) and a plurality of slave devices (1, 2, 3) serially connected to one another in such a way that the master device (5) comes to the most upstream side, thereby configuring an optical multidrop network that ensures data transmission and reception by optical communications among contiguous devices,
makes each of the slave devices (1, 2, 3) self-control so as to be in such a state as not to receive data from any slave device on a downstream side when starting an operation, and
makes the master device (5) control the individual slave devices (1, 2, 3) sequentially from an upstream side to a downstream side in such a way that each of the slave devices is capable of receiving data from a downstream side slave device.

In starting up such a network system, the master device controls the individual slave devices sequentially from the upstream side in such a way that the slave device to be controlled is capable of receiving data from a downstream side slave device. This allows the establishment of a network.

As a result, it is possible to prevent a malfunction of the network system caused by the influence of noise light entering the most downstream side slave device, add and remove any device constituting a node in the network system, and change the path freely.

A network system according to the second aspect of the invention comprises a master device (5) and a plurality of slave devices (1, 2, 3) serially connected to one another in such a way that the master device (5) comes to the most upstream side, thereby configuring an optical multidrop network that ensures data transmission and reception by optical communications among contiguous devices,
makes each of the slave devices (1, 2, 3) self-control so as to be in such a state as not to receive data from any slave device on a downstream side when starting an operation, and self-control so as to be in such a state as to be capable of receiving data from a downstream side slave device in response to control data which instructs reception of data from a downstream side slave device when receiving the control data from the master device (5),
makes the master device (5) transmit the control data toward the individual slave devices (1, 2, 3) sequentially from an upstream side to a downstream side,
wherein when there is any other slave device capable of receiving data between the slave device as a destination of the control data and the master device (5), transmission of the control data by the master device (5) is carried out via the any other slave device.

In starting up such a network system, after each slave device becomes in such a state as not to receive data from any downstream side slave device, the master device controls the individual slave devices sequentially from the upstream side in such a way that the slave device to be controlled is capable of receiving data from a downstream side slave device. This establishes a network.

As a result, it is possible to prevent a malfunction of the network system caused by the influence of noise light entering into the most downstream side slave device, add and remove any device constituting a node in the network system, and change the path freely.

According to the third aspect of the invention, there is provided a master device (5) which is serially connected to a plurality of slave devices (1, 2, 3) in such a manner as to come to the most upstream side among the plurality of slave devices (1, 2, 3), thereby configuring an optical multidrop network that ensures data transmission and reception by optical communications among contiguous devices, and
transmits control data to the slave devices (1, 2, 3) sequentially from an upstream side to a downstream side via any other slave device when there is the other slave device which is capable of receiving data between the slave device as a destination of the control data and the slave device,
wherein reception of the control data permits each of the slave devices (1, 2, 3) to self-control so as to be capable of receiving data from any slave device on a downstream side in response to the control data.

When a network system with such a master device starts up, the master device controls the individual slave devices sequentially from the upstream side in such a way that the slave device to be controlled is capable of receiving data from a downstream side slave device. This establishes a network.

As a result, it is possible to prevent a malfunction of the network system caused by the influence of noise light entering into the most downstream side slave device, add and remove any device constituting a node in the network system, and change the path freely.

According to the fourth aspect of the invention, there is provided a slave device (1, 2, 3) which is serially connected to a master device (5) in such a way that the master device (5) comes to the most upstream side, thereby configuring an optical multidrop network that ensures data transmission and reception by optical communications among contiguous devices,
self-controls so as to be in such a state as not to receive data from any slave device on a downstream side when starting an operation, and
self-controls so as to be capable of receiving data from a downstream side slave device in response to control data instructing reception of data from any downstream side slave device when receiving the control data from the master device (5).

When a network system including such a slave device starts up, the master device controls the individual slave devices sequentially from the upstream side in such a way that the slave device to be controlled is capable of receiving data from a downstream side slave device. This establishes a network.

As a result, it is possible to prevent a malfunction of the network system caused by the influence of noise light entering into the most downstream side slave device, add and remove any device constituting a node in the network system, and change the path freely.

According to the fifth aspect of the invention, there is provided a control method which is for a network system with a master device (5) and a plurality of slave devices (1, 2, 3) serially connected to one another in such a way that the master device (5) comes to the most upstream side, thereby configuring an optical multidrop network that ensures data transmission and reception among contiguous devices, and comprises the steps of:
making each of the slave devices (1, 2, 3) self-control so as to be in such a state as not to receive data from any slave device on a downstream side when starting an operation, and
making the master device (5) control the individual slave devices (1, 2, 3) sequentially from an upstream side to a downstream side in such a way that the slave device is capable of receiving data from a downstream side slave device.

According to such a control method, when a network system starts up, the master device controls the individual slave devices sequentially from the upstream side in such a way that the slave device to be controlled is capable of receiving data from a downstream side slave device. This establishes a network.

As a result, it is possible to prevent a malfunction of the network system caused by the influence of noise light entering into the most downstream side slave device, add and remove any device constituting a node in the network system, and change the path freely.

### BRIEF DESCRIPTION OF DRAWINGS

These objects and other objects and advantages of the present invention will become more apparent upon reading of the following detailed description and the accompanying drawings in which:

FIG. 1 is a block diagram of a network system according to one embodiment of the present invention;

FIG. 2 is a block diagram of the internal structure of a slave device;

FIG. 3 is a diagram showing an ID table a master device has; and

FIG. 4 is a flowchart illustrating operational procedures of the network system.

### BEST MODE FOR CARRYING OUT THE INVENTION

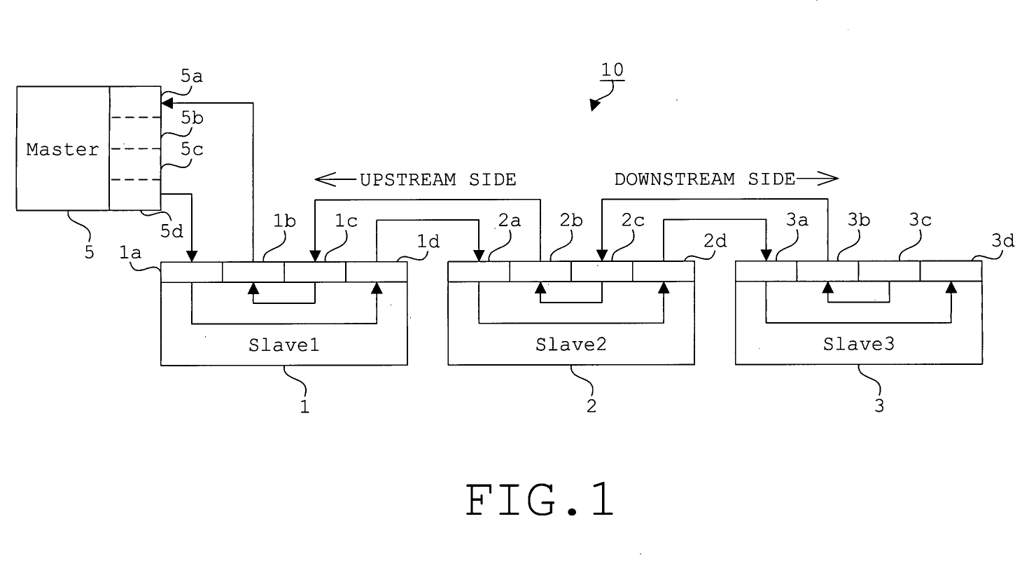

A preferred embodiment of the present invention will be described with reference to FIGS. 1 to 4. FIG. 1 is a block diagram showing the schematic structure of a network system 10 according to one embodiment of the invention. An initiation control method for the network system according to one embodiment of the invention can be carried out by the network system 10 to be described below.

The network system 10 forms an optical multidrop network. The network system 10 is connected with a master device 5, a first slave device 1, a second slave device 2, and a third slave device 3. Each of those devices forms a node of the network system 10.

The individual devices, namely the master device 5, the first to third slave devices 1 to 3 are connected serially. Specifically, the master device 5 is located at the highest rank (upmost stream) position, and the first slave device 1, the second slave device 2 and the third slave device 3 are serially connected in a downstream direction in the named order. The master device 5 and the first to third slave devices 1 to 3 are connected together by a fiber-optic cable to achieve data transmission and reception by optical communications.

Each device includes a data reception terminal and a data transmission terminal, each of which has a photoelectric converter. In receiving data transmitted from another device, each device receives the data in the form of an optical signal, converts the received optical signal to an electrical signal, and uses the electrical signal mainly in processes in the device. In transmitting data to another device, each device converts an electrical signal to an optical signal before transmission.

The master device 5 includes a main control unit (main controller) which controls the individual slave devices. The main control unit comprises a CPU (Central Processing Unit). Each of the slave devices 1 to 3 is controlled based on control data transmitted from the master device 5.

The master device 5 has a first reception terminal 5a, a first transmission terminal 5b, a second reception terminal 5c, and a second transmission terminal 5d. The master device 5 receives data transmitted from the first slave device 1 at the first reception terminal Sa. The master device 5 transmits data to the first slave device 1 from the second transmission terminal Sd.

Each slave device includes a local control unit (local controller). The local control unit comprises a CPU. Each slave device receives control data transmitted from the master device 5. The local control unit of the slave device controls the statuses of the individual components of the slave device according to the control data.

The first slave device 1 includes an upstream side data reception terminal 1a, an upstream side data transmission terminal 1b, a downstream side data reception terminal 1c, and a downstream side data transmission terminal 1d. The first slave device 1 receives data transmitted from the master device 5 at the upstream side data reception terminal 1a, and gives the data to its local control unit. The local control unit gives the received data to the downstream side data transmission terminal 1d. The downstream side data transmission terminal id transmits the data to the second slave device 2.

The first slave device 1 receives data transmitted from the second slave device 2 at the downstream side data reception terminal 1c, and gives the data to its local control unit. According to a process to be executed by the local control unit, the local control unit gives both of the received data and data locally generated to the upstream side data transmission terminal 1b, or gives the locally generated data alone to the upstream side data transmission terminal 1b.

The second slave device 2 includes an upstream side data reception terminal 2a, an upstream side data transmission terminal 2b, a downstream side data reception terminal 2c, and a downstream side data transmission terminal 2d. The second slave device 2 receives data transmitted from the first slave device 1 at the upstream side data reception terminal 2a, and gives the data to its local control unit. The local control unit gives the received data to the downstream side data transmission terminal 2d. The downstream side data transmission terminal 2d transmits the data to the third slave device 3.

The second slave device 2 transmits data to the first slave device 1 from the upstream side data transmission terminal 2b. The second slave device 2 receives data transmitted from the third slave device 3 at the downstream side data reception terminal 2c, and gives the data to its local control unit. According to a process to be executed by the local control unit, the local control unit gives both of the received data and data locally generated to the upstream side data transmission terminal 2b, or gives the locally generated data alone to the upstream side data transmission terminal 2b.

The third slave device 3 includes an upstream side data reception terminal 3a, an upstream side data transmission terminal 3b, a downstream side data reception terminal 3c, and a downstream side data transmission terminal 3d. The third slave device 3 receives data transmitted from the second slave device 2 at the upstream side data reception terminal 3a.

The third slave device 3 transmits data to the second slave device 2 from the upstream side data transmission terminal 3b. The third slave device 3 is located at the most downstream position in the multidrop network where the network system 10 is formed. Therefore, the downstream side data reception terminal 3c and the downstream side data transmission terminal 3d are open.

In the network system 10, data that is transmitted to each slave device is transmitted to all the slave devices from the topmost slave device 1 to the slave device 2, and then to the lowermost slave device 3 in order.

For example, in case where the master device 5 transmits data to the second slave device 2, the master device 5 transmits the data to the slave device 1. The slave device 1 then transmits the data to the slave device 2.

In case where the slave device 1, 2, or 3 transmits data to the master device 5, the sender slave device first transmits the data to a slave device higher than the sender slave device by one in the direction toward the master device 5, then data-received slave device transmits the data to a next slave device higher by one, and so forth until the data reaches the master device 5.

For data transmission and reception among a plurality of slave devices, a sender slave device transmits data to a contiguous slave device, then to a farther slave device, and so forth to the destination slave device.

In case where the master device 5 transmits data to the slave devices, the address (ID) of the destination slave device is affixed to data to be transmitted. Each slave device determines from the affixed address whether the transmitted data is addressed to the local slave device or not. When each slave device determines that the transmitted data is not addressed to the local slave device, the slave device neglects the data. When the slave device determines that the transmitted data is addressed to the local slave device, the slave device receives the data.

Upon reception of the data transmitted from the master device 5, each slave device returns reception complete data representing acknowledgement of the reception of the data to the master device 5. Upon reception of reception complete data, the master device 5 detects that the data transmitted from the master device 5 to the slave device which has sent the reception complete data has been received properly.

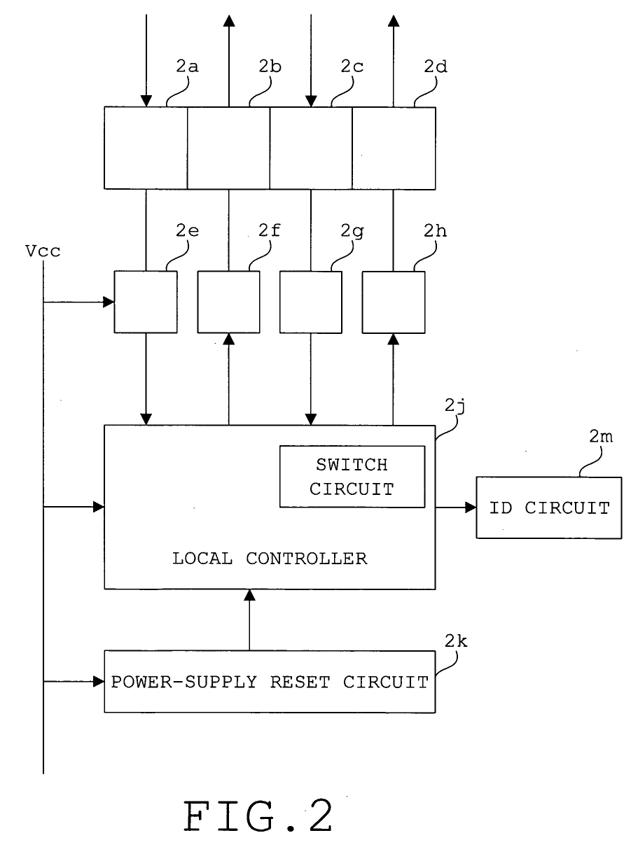

An explanation will be given below of the internal structure of the slave devices taking the second slave device 2 as a representative one. FIG. 2 is a block diagram showing the schematic internal structure of the second slave device 2. A first photoelectric converter 2e is connected to the upstream side data reception terminal 2a. A second photoelectric converter 2f is connected to the upstream side data transmission terminal 2b. A third photoelectric converter 2g is connected to the downstream side data reception terminal 2c. A fourth photoelectric converter 2h is connected to the downstream side data transmission terminal 2d.

The photoelectric converters 2e and 2g convert an optical signal to an electrical signal. The photoelectric converters 2f and 2h convert an electrical signal to an optical signal. A signal output from the photoelectric converter 2e and a signal output from the photoelectric converter 2g are input to a local controller 2j. A signal output from the local controller 2j is input to the photoelectric converters 2f and 2h.

The slave device 2 comprises the local controller 2j and an ID circuit 2m. The local controller is equivalent to the local control unit. The local controller 2j receives the signal from the first photoelectric converter 2e, processes data of the received signal inside, and sends the received signal to the second photoelectric converter 2f. ID circuit 2m, which comprises, for example, a switch, determines the address (ID) of the slave device 2.

To determine whether the data of the signal received from the first photoelectric converter 2e is to be processed inside or not, the local controller 2j discriminates whether the address (ID) of the received signal matches with the address (ID) of the ID circuit 2m or not. When the two addresses do not have a match, the uppermost stream 2j does not fetch the data of the received signal inside. When the two addresses have a match, the local controller 2j fetches the data of the received signal inside. Then, the local controller 2j performs a process according to the data inside, or performs a process according to the data for a device (not shown) connected to the local controller 2j.

The local controller 2j has a switch circuit that controls reception of a signal from the third photoelectric converter 2g. The switch circuit is controlled according to the logical status of the local controller 2j, and determines whether to set the slave device 2 to a reception enable state or to a reception disable state. In the reception enable state, the local controller 2j fetches the signal received by the third photoelectric converter 2g and sends the signal to the fourth photoelectric converter 2h. In the reception disable state, the controller 2j does not fetch the signal received by the third photoelectric converter 2g and the signal is not output to the fourth photoelectric converter 2h. Control on the switch circuit is executed in an initialization process which will be discussed later, or is also executed when control data of the switch circuit is acquired as a result of processing the data of the signal received from the first photoelectric converter 2e by the local controller 2j.

The local controller 2j generates an acknowledgement signal and sends the signal to the fourth photoelectric converter 2h when the local controller 2j fetches the data of the signal received from the first photoelectric converter 2e and processes the data adequately. The local controller 2j generates a non-acknowledgement signal and sends the signal to the fourth photoelectric converter 2h when the local controller 2j cannot process the data adequately. There are two cases where a signal is output to the fourth photoelectric converter 2h. In the first case, only the acknowledgement/non-acknowledgement signal from the local controller 2j is output. In the other case, the logical sum of the signal received by the third photoelectric converter 2g and the acknowledgement/non-acknowledgement signal from the local controller 2j is output. Which case to take place is determined by the state of the switch circuit.

The slave device 2 has a power-supply reset circuit 2k. The power-supply reset circuit 2k performs a power-supply reset process when the slave device 2 is powered on. When the power-supply reset circuit 2k performs the power-supply reset process, the local controller 2j performs the initialization process to be discussed later.

The master device 5 has photoelectric converters, a main controller, and a power-supply reset circuit. An optical signal input to the reception terminal of the master device 5 is converted to an electrical signal by the photoelectric converter connected to the reception terminal. The electrical signal is input to the main controller of the master device 5. An electrical signal output from the main controller is converted to an optical signal by the photoelectric converter connected to the transmission terminal of the master device 5. The optical signal is then transmitted from the transmission terminal.

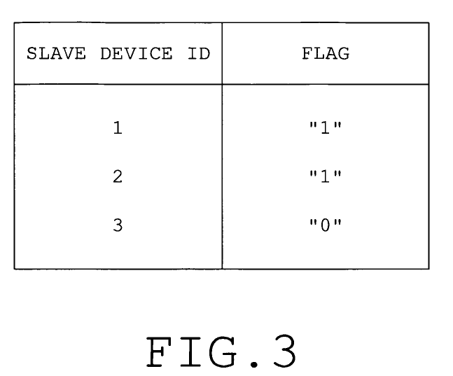

The master device 5 has a memory area where an ID table is stored. FIG. 3 is a diagram showing an example of the ID table the master device 5 has. The ID table stores the addresses (IDs) of the individual slave devices, and a flag representing whether each slave device has responded or has not responded, in association with each other. A value “0” of the flag shows that a slave device has not responded to an inquiry from the master device 5, while a value “1” shows that a slave device has responded to the inquiry from the master device 5.

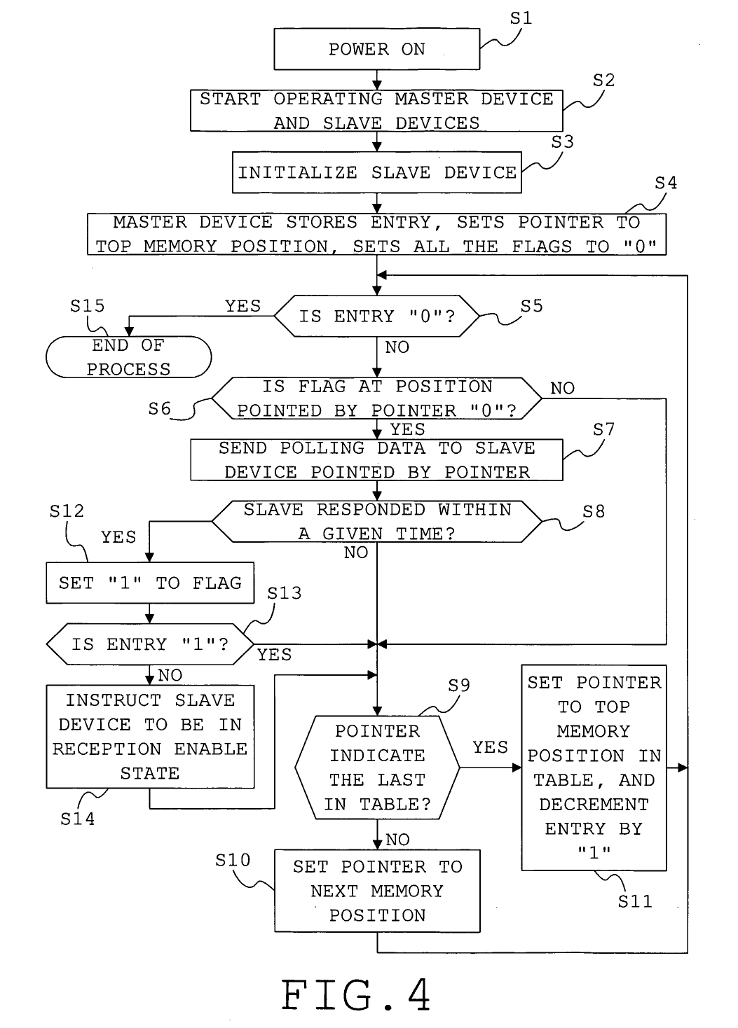

Next, an example of an operation of starting up the network system 10 will be explained with reference to FIG. 4. FIG. 4 is a flowchart illustrating the steps of the operation of the network system 10.

As the network system 10 is powered on (step S1), the slave devices 1, 2, and 3 and the master device 5 are powered on. The master device 5 and the slave devices 1, 2, and 3 start operating (step S2).

The local controller of each of the slave devices 1, 2, and 3 controls the switch circuit which controls the reception of the signal from its third photoelectric converter in such a way that switch circuit goes to in the reception disable state (i.e., the logical state where the local controller does not fetch the signal received by the third photoelectric converter). As a result, each slave device disregards data input to the downstream reception terminal, and self-controls so as to be in such a state as not to receive data (step S3). At step S3, while each slave device does not receive data input to its downstream reception terminal, the slave device 1 is in such a state as to be capable of communicating with the master device 5.

When starting an operation, the master device 5 checks which slave device is the last terminal among the slave devices connected to the network system 10, and performs an operation of establishing the network.

That is, the master device 5 identifies and stores the number of the addresses (IDs) (the number of entries) registered in the ID table. The master device 5 sets the value of the pointer that indicates the memory position for the flag to be referred to next in the ID table at the memory position fir the top address in the ID table. The master device 5 sets all of the values of the flags in the ID table to “0” (step S4).

Next, the master device 5 discriminates whether or not the value of the currently stored entry is “0” (step S5). When the value of the entry is not “0” (step S5: NO), the master device 5 discriminates the value of the flag associated with the address pointed by the pointer (step S6). When the value of the flag is not “0” (step S6: NO), the master device 5 considers that it is confirmed that the slave device with that address (ID) has already responded, and proceeds to step S9.

When the value of the flag is “0” (step S6: YES), the master device 5 considers that the response of the slave device with the address (ID) pointed by the pointer has not been confirmed yet, and sends the slave device having the address (ID) polling data which instructs the slave device to return an acknowledgement signal only (step S7). The master device 5 waits for the response from the slave device for a given time (step S8).

When there is no response from the slave device as the destination of the polling data for the given time after the execution of the process at the step S7 (step S8: NO), the master device 5 checks if the pointer indicates the memory position for the last address (ID) registered in the ID table (step S9). If the pointer does not point the last address (step S9: NO), the master device 5 sets the pointer so as to point the memory position for the next address to confirm the slave device (1, 2, and 3) at the next address (ID) (step S10), and returns to the step S5.

If the memory position pointed by the pointer is the last address (ID) in the ID table (step S9: YES), the master device 5 sets the value of the pointer at the memory position for the top address in the ID table, decrements the value stored as the value of the entry by “1” (step S11), and returns to the step S5.

When there is the response from the slave device as the destination of the polling data in the given time after the execution of the process at the step S7 (step S8: YES), the master device 5 sets the value “1” which indicates that the slave device has already responded to the flag associated with the address pointed by the pointer (step S12).

Next, the master device 5 determines whether or not the currently stored value as the value of the entry is “1” (step S13).

If the current value of the entry is not “1” (step S13: NO), the master device 5 considers that the last slave device responded is not the last terminal among the slave devices connected to the master device 5, sends data which instructs that slave device, i.e., the slave device (1, 2, or 3) with the address currently pointed by the pointer data instructing the slave device to go to the reception enable state (step S14), and proceeds to the step S9.

In the step S13, if the current value of the entry is “1” (step S13: YES), the master device 5 considers that the last slave device responded is the last terminal among the slave devices connected to the master device 5, and proceeds to the step S9 with the slave device kept in the reception disable state.

When having discriminated at the step S5 that the current value of the entry is “0” (step S5: YES), the master device 5 determines that there is no slave device in the network system 10 that has not responded yet, and completes the process of establishing the network (step S15).

According to the above-described network system 10, at the time the operation of the network system 10 starts, each of the slave devices first goes to such a state as not to receive data from any downstream side slave device.

Next, starting from the slave device located near the master device 5, each of the slave devices is so set as to be capable of receiving data transmitted from a downstream side slave device, and the slave device at the last terminal is set in such a state as not to receive data transmitted from any downstream device, completing the establishment of the network.

This results in prevention of a phenomenon such that external noise light entering the slave device 3 at the last terminal causes a malfunction of the network system 10. This makes it possible to prevent the malfunction of the network system 10 while facilitating addition of a device which constitutes a node in the network system 10.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

The present application claims a priority under the Paris Convention based on Japanese Patent Application No. 2004-316643 filed in Japan Patent Office on Oct. 29, 2004, and the disclosure of the application is hereby incorporated in this specification by reference.

1. A network system which comprises a master device and a plurality of slave devices serially connected to one another in such a way that said master device comes to the most upstream side, thereby configuring an optical multidrop network that ensures data transmission and reception by optical communications among contiguous devices,
makes each of said slave devices self-control so as to be in such a state as not to receive data from any slave device on a downstream side when starting an operation, and
makes said master device control said individual slave devices sequentially from an upstream side to a downstream side in such a way that each of said slave devices is capable of receiving data from a downstream side slave device.

2. A network system which comprises a master device and a plurality of slave devices serially connected to one another in such a way that said master device comes to the most upstream side, thereby configuring an optical multidrop network that ensures data transmission and reception by optical communications among contiguous devices,
makes each of said slave devices self-control so as to be in such a state as not to receive data from any slave device on a downstream side when starting an operation, and self-control so as to be in such a state as to be capable of receiving data from a downstream side slave device in response to control data which instructs reception of data from a downstream side slave device when receiving said control data from said master device,
makes said master device transmit said control data toward said individual slave devices sequentially from an upstream side to a downstream side,
wherein:
each of said slave devices comprises an address circuit which determines an address of the slave device;
said master device transmit said control data together with an address of a destination slave device affixed thereto;
each one of said slave device determines, from the address affixed to the control data transmitted from said master device, whether the control data is addressed to the one slave device or not, and receives the control data when it is determined to be addressed to the one slave device, whereby each one of said slave devices responds only to the control data to which its address is affixed; and
when there is any other slave device capable of receiving data between said slave device as a destination of said control data and said master device, transmission of said control data by said master device is carried out via said any other slave device.

3. A master device which is serially connected to a plurality of slave devices in such a manner as to come to the most upstream side among said plurality of slave devices, thereby configuring an optical multidrop network that ensures data transmission and reception by optical communications among contiguous devices, and
transmits control data to said slave devices sequentially from an upstream side to a downstream side via any other slave device when there is said other slave device which is capable of receiving data between said slave device as a destination of said control data and said master device,
wherein:
each of said slave devices comprises an address circuit which determines an address of the slave device;
said master device transmit said control data together with an address of a destination slave device affixed thereto;
each one of said slave device determines, from the address affixed to the control data transmitted from said master device, whether the control data is addressed to the one slave device or not, and receives the control data when it is determined to be addressed to the one slave device; and
reception of said control data permits each of said slave devices to self-control so as to be capable of receiving data from any slave device on a downstream side in response to said control data.

4. A slave device which is serially connected to a master device in such a way that said master device comes to the most upstream side, thereby configuring an optical multidrop network that ensures data transmission and reception by optical communications among contiguous devices,
self-controls so as to be in such a state as not to receive data from any slave device on a downstream side when starting an operation, and
self-controls so as to be capable of receiving data from a downstream side slave device in response to control data instructing reception of data from any downstream side slave device when receiving said control data from said master device,
wherein:
said slave devices comprises an address circuit which determines an address of the slave device;
said master device transmit said control data together with an address of a destination slave device affixed thereto;
said slave device determines, from the address affixed to the control data transmitted from said master device, whether the control data is addressed to the slave device or not, and receives the control data when it is determined to be addressed to the slave device, whereby said slave devices responds only to the control data to which its address is affixed.

5. A control method which is for a network system with a master device and a plurality of slave devices serially connected to one another in such a way that said master device comes to the most upstream side, thereby configuring an optical multidrop network that ensures data transmission and reception among contiguous devices, and comprises the steps of:
making each of said slave devices self-control so as to be in such a state as not to receive data from any slave device on a downstream side when starting an operation, and
making said master device control said individual slave devices sequentially from an upstream side to a downstream side in such a way that said slave device is capable of receiving data from a downstream side slave device.
